(19) United States
(12) Patent Application Publication
(10) Pub. No.: US 2010/0251222 A1
(43) Pub. Date: Sep. 30, 2010

(54) COMPLETENESS DETERMINATION IN SMT-BASED BMC FOR SOFTWARE PROGRAMS

(75) Inventor: Malay Ganai, Plainsboro, NJ (US)

Correspondence Address: BROSEMER, KOLEFAS & ASSOCIATES, LLC (NECL), ONE BETHANY ROAD BUILDING 4 - SUITE #58, HAZLET, NJ, 07730, US

(73) Assignee: NEC Laboratories America, Princeton, NJ (US)

(21) Appl. No.: 12/410,429

(22) Filed: Mar. 24, 2009

(51) Int. Cl. G06F 9/44; G06F 9/45

(52) U.S. Cl. 717/135; 703/22

(57) ABSTRACT

A computer implemented method for obtaining a completeness threshold (CT) in Bounded Model Checking systems for software programs.

### FIELD OF DISCLOSURE

This disclosure relates to the formal analysis and verification of computer software.

### BACKGROUND OF DISCLOSURE

Bounded Model Checking (BMC) is a model checking technique in which the falsification of a given Linear Temporal Logic (LTL) property φ is checked at a given sequential depth. Notably, BMC has been successively applied to verify a number of real-world designs.

Typically BMC methods comprise the following steps: 1) unrolling the design for k time frames, 2) translating a BMC instance into a decision problem Ψ such that Ψ is satisfiable iff φ has a counter-example of depth (less that or) equal to k, and 3) using a decision procedure to check if Ψ is satisfiable. In Satisfiability Modulo Theory (SMT)-based BMC, Ψ is a quantifier-free formula (QFP) in a decidable subset of first order logic, which is then checked for satisfiability by an SMT solver. With the growing use of high-level design abstraction to capture today's complex design features, the focus of verification techniques has been shifting towards using SMT solvers, and SMT-based BMC which can potentially provide more scalable alternatives than SAT-based or BDD-based methods. As known by those skilled in the art, BMC—in general—is incomplete unless checking is performed up to the completeness threshold (CT) bound.

Generally speaking however, computing CT bound is computationally expensive. In a typical verification scenario having multiple properties to resolve, it is not often clear how to devise a good verification procedure, i.e., how to balance the limited time resource between proving and falsifying the correctness properties. Therefore, it is important to reduce the time for computing completeness threshold.

### SUMMARY OF DISCLOSURE

An advance is made in the art according to the principles of the present disclosure directed to a computer implemented method for determining the completeness threshold for SMT-Based BMC for software programs.

In sharp contrast to prior art methods which use a recurrence diameter for obtaining CT, and check for existence of a longest loop-free path at every depth k, the method according to the present disclosure only requires solving a formula of size O(k) at some depths only, as compared to the prior art methods that require solving a formula of O(k²)(orO(k(log k)) size at every depth.

### BRIEF DESCRIPTION OF THE DRAWING

A more complete understanding of the disclosure may be realized by reference to the accompanying drawing in which:

FIG. 1 is a sample C program and its EFSM M;;

FIG. 2 is a schematic flow diagram depicting SMT-based BMC;

FIG. 3 is a set of steps associated with an SMT-based BMC;

FIG. 4 is a set of steps associated with context-sensitive PB;

FIG. 5 is a set of steps associated with context-sensitive CSR;

FIG. 6 is a set of graphs showing the results of combining context-sensitive CSR with context-sensitive PB/CXT; and

FIG. 7 is an exemplary machine comprising a computer that performs the present method.

### DESCRIPTION OF EMBODIMENTS

The following merely illustrates the principles of the various embodiments. It will thus be appreciated that those skilled in the art will be able to devise various arrangements which, although not explicitly described or shown herein, embody the principles of the embodiments and are included within their spirit and scope.

Furthermore, all examples and conditional language recited herein are principally intended expressly to be only for pedagogical purposes to aid the reader in understanding the principles of the embodiments and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures depicting the principles of the embodiments.

By way of additional background, note that for a safety property Gp (where p is a non-temporal expression), optimum CT is shown to be equal to the reachability diameter rd, i.e., the longest shortest path from the initial state. Finding rd requires solving a Quantified Boolean Formula (QBF) with increasing k, and is computationally expensive.

Instead, one can compute the recurrence reachability diameter rrd, i.e., the longest loop-free path, by computing a series of SAT checks with increasing k. Such computation requires solving SAT instances of size O(k²). Thus, each CT check for computing rrd is quadratic in size of depth and becomes harder to solve with unrolling.

It is known that the size of the formula can be further reduced to O(k log k) using a sorting network. In practice, however, the approach has a limitation since the optimal size of a sorting network for an arbitrary input size is unknown. As every shortest path is loop-free path, rrd over-approximates rd, i.e., rrd≧rd and hence, CT so obtained is sub-optimal.

Although BMC has been used primarily for verifying hardware designs, it has also been used in verifying low-level software programs in C. Most application software programs terminate. Embedded software programs however, which are typically reactive, do not terminate for correct functionality. Additionally, for embedded programs that require a high degree of reliability, dynamic memory allocations and recursion are typically discouraged.

In the present disclosure we focus on devising efficient proof techniques for terminating software programs in an SMT-based BMC framework. Specifically, we focus on computing rrd efficiently for determining completeness threshold for verifying low-level embedded programs under the assumptions of finite recursion and finite data. We formulate common design errors such as array bounds violations, null pointer dereferences, use of unitialized variables, and user-provided assertions as reachability properties, and solve them using BMC.

Accordingly to the present disclosure, a new formulation for determining CT is demonstrated that requires solving an SMT/SAT formula of size O(k) corresponding o the longest non-terminating path (NTP) in the program. It is shown that for a terminating program, the length of the longest. NTP corresponds to the recurrence diameter of the corresponding extended finite state machine (EFSM). Using control flow information, our formulation advantageously eliminates the need to check for CT at every BMC unroll depth.

Advantageously, the present disclosure augments BMC simplifications using model transformation and control flow information, with context-sensitive analysis. This allows the method to be applicable for a model with an irreducible control flow graph (CFG), which results in the number of CT checks. As is frequently the case, the CFG oftentimes become irreducible due to function calls not being inlined.

By reducing the time for computing completeness threshold, we provide a workable balance between falsification and proof methods, thereby, obtaining an effective verification procedure. Experimental evaluations on real world software programs show that techniques according to the present disclosure result in several order-of-magnitude improvement in performance, compared to previous approaches in SMT/SAT-based BMC.

### EFSM Completeness Threshold

An EFSM model M is a 5-tuple (s₀, C, I, D, T) where s₀ is an initial state, C is a set of control states (or blocks), I is a set of inputs, D is an η dimensional space D₁x . . . xD_{η} (each point in D denotes a valuation of η datapath with variables with possibly infinite ranges), and T is a set of 4-tuple (c, x, c′,x′) transitions where c, c′∈ C and x, x′∈ D. An ordered pair <c,x>∈ CxD is called a configuration or state of M.

Let g: DxI [symbol] B={0, 1} denote a Boolean-valued enabling condition (or guard), and u:DxI [symbol] D denote an update function. A transition from a state <c,x> to <c′,x′> under enabling predicate g(x,i), and update relation u(x,i,x′) is denoted as

$$< c , x > {\to }^{g / u} < {c}^{′} , {x}^{′} > .$$

A NOP state is a control state with no update transition and a single incoming (outgoing) transition. A SINK (SOURCE) state is a unique control state with no outgoing (incoming) transition.

For an EFSM M and an LTL property φ, if φ holds in M up to k transition (or depth), we write M|=kφ, and if φ holds in M for all k, we simply write M|=φ. Let sᵢ≡<cᵢ,xᵢ> denote a state, and T(sᵢ,sᵢ₊₁) denote a state transition relation.

We define a path as a sequence of successive states, i.e.,

$$path ( {s}_{0} … k ) {=}^{def} {⋀}_{0 \leq i < k} T ( {s}_{i} , {s}_{i + 1} ) \qquad ( 1 )$$

A path has length k if it makes k transitions. (s₀, . . . ,sₖ). A loop free path (LFP) is a path where all states in the path are distinct, i.e.,

$$L F P ( {s}_{0} … k ) {=}^{def} path ( {s}_{0} … k ) ⋀ {⋀}_{0 \leq i < j < k} {s}_{i} \neq {s}_{j} \qquad ( 2 )$$

The recurrence diameter, denoted rrd, is the longest LFP in M, i.e.,

$$rrd ( M ) {=}^{def} max \{ i \vert ∃ {s}_{0} … {s}_{i} ⋀ L F P ( {s}_{0} … i ) \} \qquad ( 3 )$$

A completeness threshold CT(M, φ) is defined as the minimum number of cycles such that if φ holds up to CT(M, φ), it holds in M for all depths k, i.e.,

$$C T ( M , φ ) {=}^{def} min \{ i \vert M \vert {=}_{i} φ \to M \vert = φ \} \qquad ( 4 )$$

Building Models from C Threads

At this point, we may now briefly discuss our model building step from a given C program under the assumption of a bounded heap and a bounded stack. We obtain first a simplified CFG by flattening the structures and arrays into scalar variables of simple types (Boolean, integer, float). We handle pointer accesses using direct memory access on a finite heap model, and apply standard slicing and constant propagation. We do not inline non-recursive procedures to avoid blow up, but bound and inline recursive procedures. From the simplified CFG, we build an EFSM where each block is identified by a unique id value, and a control state variable PC denotes the current block id. We construct a symbolic transition relation for PC, that represents the guarded transitions between the basic blocks. For each data variable, we construct an update transition relation based on the expressions assigned to the variable in various basic blocks in the CFG. We use Boolean expressions and arithmetic expressions to represent the update and guarded transition relations. The common design errors mentioned earlier are modeled as ERROR blocks. In this work, we focus on the reachability of such ERROR blocks. In the sequel, an EFSM state is also referred as a program sate.

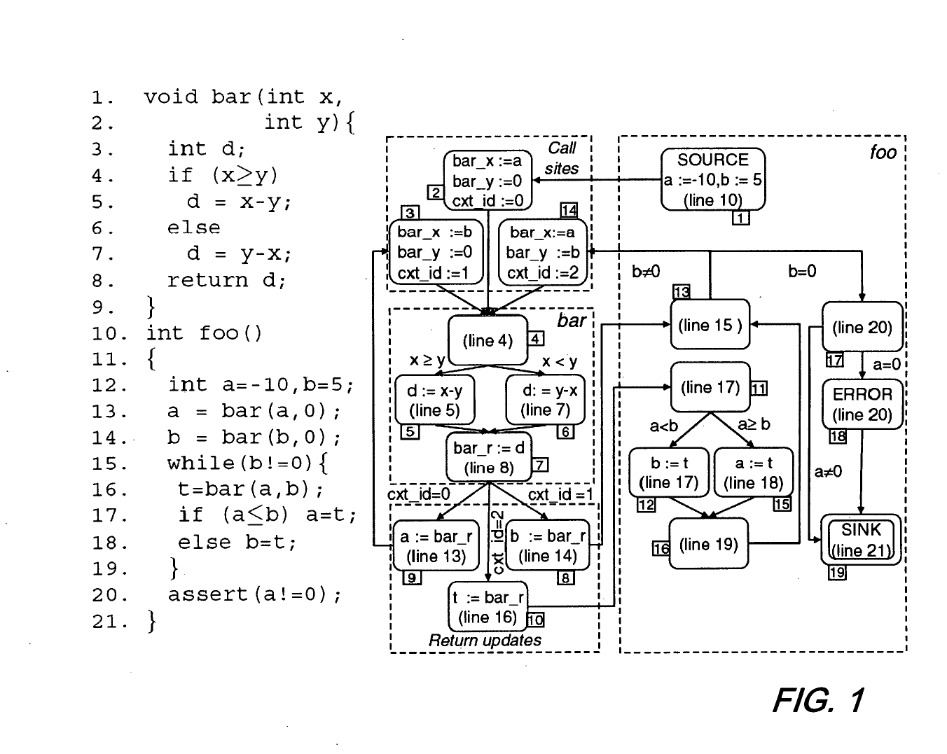

FIG. 1 shows a sample C program, and its corresponding EFSM M obtained by our modeling. Each box represents a control state (or basic block) and the unique number in the attached square denotes its id. For example, the edge (4,5) represents a transition from block 4 to 5, predicated on x≧y, with update function d:=x−y . Blocks 4 and 5 correspond to source lines 4 and 5, respectively. We obtain a CFG by simply ignoring the enabling predicates and update functions. Blocks 4 and 7 are entry and exit blocks of function bar, respectively. Block pairs (2,9), (3,8) and (14,10) correspond to call and return sites for bar. The variable ext_id is introduced to identify the different calling contexts i.e., call/return sites.

### CSR and CFG Transformations

CSR, i.e., control state reachability, is a breadth-first traversal of the CFG (corresponding to an EFSM model), where a control state b is one step reachable form a iff there is some enabling transition a→b. At a given sequential depth d, let R(d) represent the set of control states that can be reached statically, i.e., ignoring the guards, in one step from the states in R(d−1), with R(O)= . . . . We say a control state a is CSR-reachable at depth k if a ∈ R(k). For some d, if R(d−1)≠R(d)=R(d+1), we say the CSR saturates at depth d.

Computing CSR for the CFG of M (in FIG. 1), we obtain the set R(d) for 0≦d≦8 as follows:
R(0)={1}, R(1)={2}, R(2)={4}, R(3)={5,6}, R(4)={7}, R(5)={8,9,10}, R(6)={13,3,11}, R(7)={14,17,4,12,15}, R(8)={4,18,19,5,6,16}

CSR can be used to reduce the size of BMC instances [9]. Basically, if a control state r ∉ R(d), then the unrolled datapath expressions of variables that depend on r can be simplified at depth d.

### Termination-Based Completeness Threshold

For terminating programs, we propose a CT (Eq. 4) that requires solving an SMT/SAT formula of size O(k) at depth k, and show that CT so obtained corresponds to the recurrence diameter. We define a non-terminating path (NTP) as a program path where the last control state cₖ (recall, sᵢ≡<cᵢ,xᵢ>) is not a SINK, i.e.,

$$N T P ( {s}_{0} … k ) {=}^{def} path ( {s}_{0} … k ) ⋀ ( {c}_{k} \neq SINK ) \qquad ( 5 )$$

We define the longest program length (of M), denoted as lpl, as the length of the longest NTP, i.e.,

$$l p l {=}^{def} max \{ i \vert ∃ {s}_{0} … {s}_{i} ⋀ N T P ( {s}_{0} … i ) \} \qquad ( 6 )$$

Lemma 1 For terminating program, each path satisfying NTP (s₀ . . . k) has distinct states, i.e., ∀₀≦i≦j≦k sᵢ≠sⱼ. Proof: We prove by contradiction. For some i<j, assume sᵢ=sⱼ. As NTP(s₀ . . . k) is SAT, cᵢ,cⱼ≠SINK. In other words, there exists an NTP path where the program state is revised. Such a loop would make the programs non-terminating, contradicting our assumption. Thus, each state in path satisfying NTP has to be distinct.

Therom 1 For a terminating program, NTP (s₀ . . . k) is SAT if and only if LFP (s₀ . . . k+1) is SAT.

Proof: (if:) Given, LFP (s₀ . . . k+1) is SAT. sₖ≡<cₖ,xₖ>≠sₖ₋₁≡<cₖ₊₁,xₖ₊₁>. Since SINK does not have any outgoing transition, clearly cₖ≠SINK. Thus, NTP (s₀ . . . k) is SAT (only if:) Given, NTP (s₀ . . . k) is SAT. Using Lemma 1, ∀₀≦i≦j≦k sᵢ≠sⱼ. Thus LFP(s₀ . . . k+1). Is SAT.

From Theorem 1, the recurrence diameter rrd (Eq. 3) corresponds to the longest non-terminating path lpl, i.e., rrd=lpl+1. Comparing formulation of NTP (Eq. 5) and LFP (Eq. 2) at depth k, we observe that the NTP formula has O(k) size, while the LFP formula has O(k²). In general, to show BMC completeness, one needs to solve an LFP formula for increasing depth k, starting from k=0[3]. Using the following theorem, we show that with the NTP formulation, together with CSR information, we can skip NTP checks, i.e., satisfiability checks for NTP(s₀ . . . k) at some k such that SINK ∉ R(k). Note, if SINK∉ R(k) and |R(k)|=1, we obtain CT=k immediately.

Therom 2 For a terminating program, if NTP (s₀ . . . k−1) is SAT and SINK ∈ R(k), then NTP (s₀ . . . k) is SAT. Proof: As SINK ∈ R(k), there is a transition from a cₖ₋₁ to cₖ≠SINK. Clearly, NTP (s₀ . . . k) is SAT.

SMT-Based BMC with NTP Check

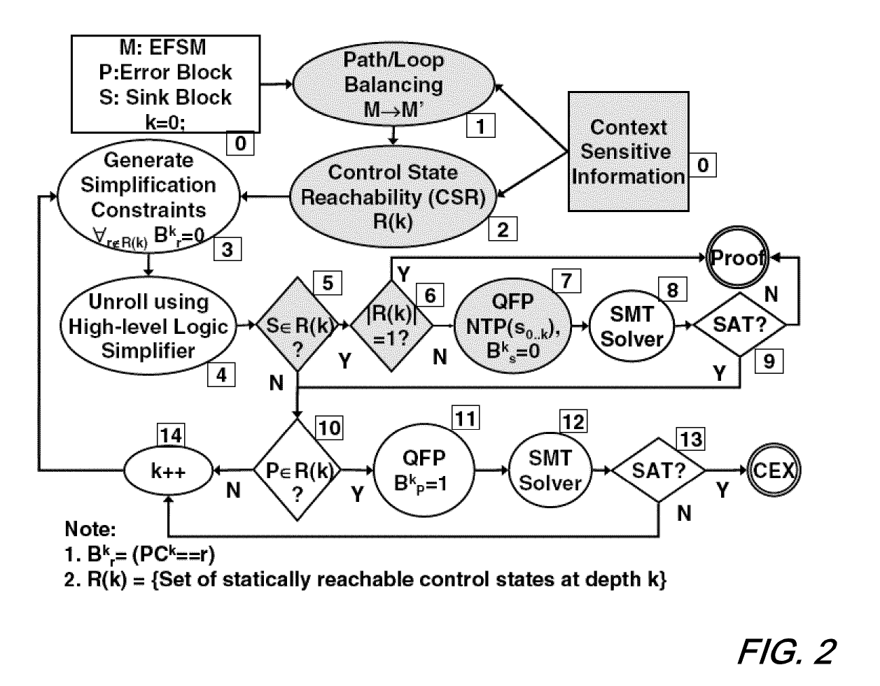

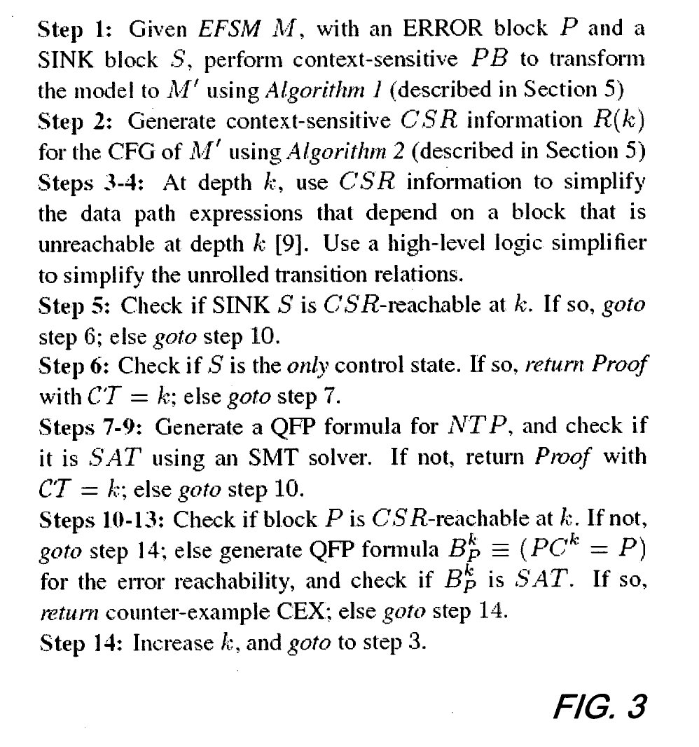

We present the flow of SMT-based BMC with NTP checks, as shown in FIG. 2. (Shaded blocks 0-2,5-7 correspond to our contributions.) Note that the flow is applicable to both terminating and non-terminating programs; however we will not obtain a CT bound for the latter. By focusing our proof techniques for terminating programs, we obtain an effective balance between falsification and proof methods. Note, we avoid an expensive LFP check that hardly ever succeeds in practice for non-terminating programs. We describe the flow in FIG. 3, where each step number matches the tagged block in FIG. 2.

Note that calls to an SMT solver for NTP checks are made only when the SINK block is CSR-reachable at that depth. Also, when (R)k)=0 for k>d during CSR. We immediately obtain CT=d. In such cases (typically seen in programs without loops), we do not perform NTP checks at all (not shown in the flow). In the following, we discuss techniques that further reduce the number of NTP checks by reducing static reachability of SINK.

### Context-Sensitive PB and CSR

A large cardinality of the set R(d), i.e., |R(d)|, reduces the scope of above simplification and hence, the performance of BMC. Re-converging paths of different lengths and different loop periods are mainly responsible for the saturation of CSR. Typically, saturation of CSR leads to large |R(d)|, and adversely affects the size of the unrolled BMC instances.

To avoid saturation, a strategy called Path/Loop Balancing (PB) has been proposed. PB transforms an EFSM by inserting NOP state does not change the transition relation of any variable. Te PB techniques are applicable only when the CFG is reducible. A reducible graph has the property that there is no jump into the middle of a loop from outside, and there is only one entry node per loop. Note that the CG of M, shown in FIG. 1, is not reducible, although the corresponding program is well-structured, i.e., has only a reducible loop.

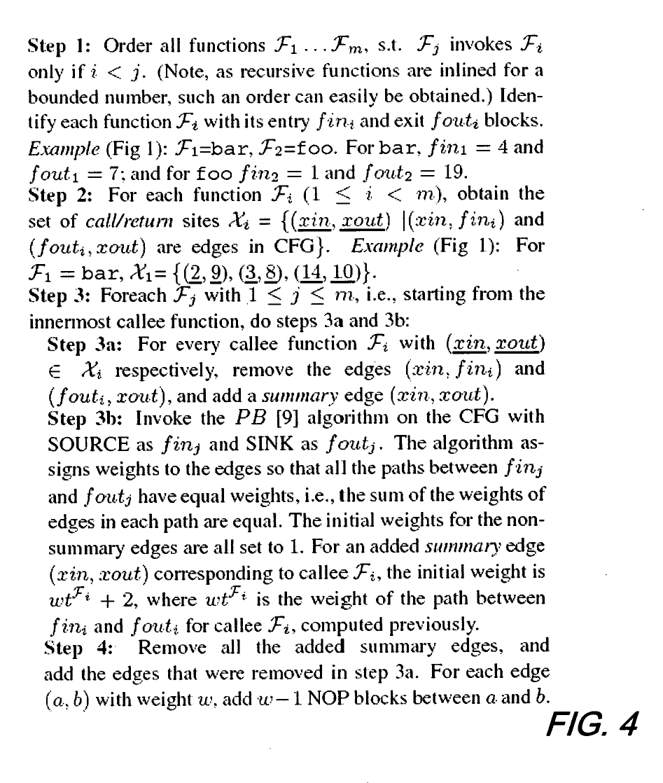

The introduction of unstructured loops during modeling causes irreducibility. For CFG in FIG. 1, the loop 3→4→5→7→9→3 is unstructured, and is not present in the original program. Such false loops are introduced due to non-inlining of functions. We overcome this problem by making PB strategy context-sensitive as described by Algorithm 1 in FIG. 4. (One can inline function calls, but EFSM may blow-up in size.)

A run of Algorithm 1: Consider the CFG shown in FIG. 1. The first call to bar does not add any NOP states as all paths are balanced. Not, that wt^{bar}=2. When we process foo, we add summary edge (2,9) with weight 4, and remove edges (2,4) and (7,9). Similarly, we add summary edges (3,8)(and (14,10). Then, we apply the PB algorithm [9]. In step 4, we remove the summary edges, and put back the removed edges. Finally, we insert 1 NOP between blocks 17 and 19.

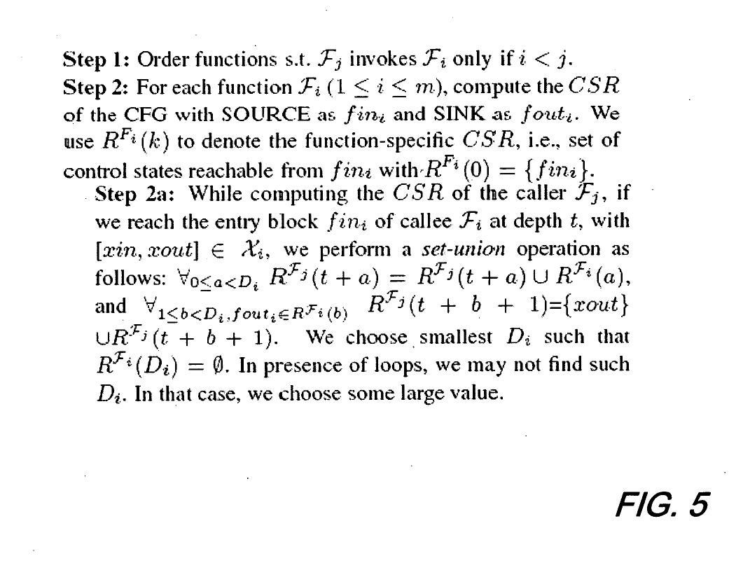

CSR analysis, in general, is not context-sensitive. This leads to large R(k), as many false paths through CFG are considered. We make it context-sensitive as described by Algorithm 2 in FIG. 5.

A run of Algorithm 2: Consider the CFG shown in FIG. 1 For function bar, we obtain R^{bar}(1)={5,6}, R^{bar}(2)={7}. For function foo, we obtain
R^{foo}(0)={1}, R^{foo}(1)={2}, R^{foo}(2)={4}, R^{foo}(3)={5,6}, R^{foo}(4)={7}, R^{foo}(5)={9},
   and so forth.

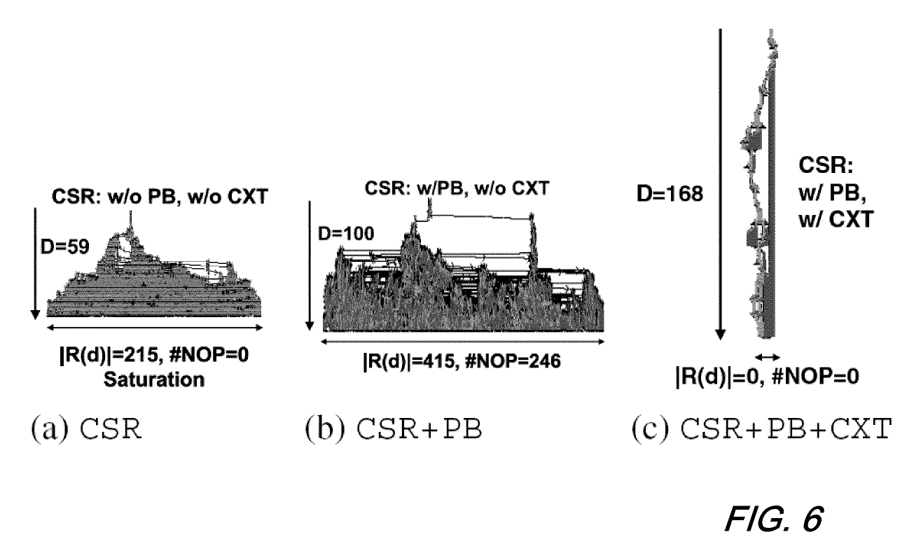

To show the effect of context-sensitive analysis on PB and CSR, we experimented with various combinations of strategies on a real-world test case tcas (air traffic control and avionic system). Not, PB refers to context-sensitive path/balancing technique (as the model is irreducible), and CXT refers to context-sensitive CSR. We compare CSR in the following settings: (a) CSR: model with no PB and no CXT, (b) CSR+PB: model with PB, but no CXT, and (c) CSR+PB+CXT: model with PB and CXT. We present their reachability graphs in FIG. 6(a)-(c) up to depth D. The width of the graph, proportional to |R(d)| where 0≦d≦D, indicates the scope of BMC simplification. We observed that using method CSR, SINK block appears at every depth after saturation; using method CSR+PB, it appears every other depth; and using method CSR+PB+CXT, it appears only once. As the method CSR+PB+CXT reduces R(d) and static reachability of SINK significantly, it also has the largest potential to improve performance of BMC.

### Experiments

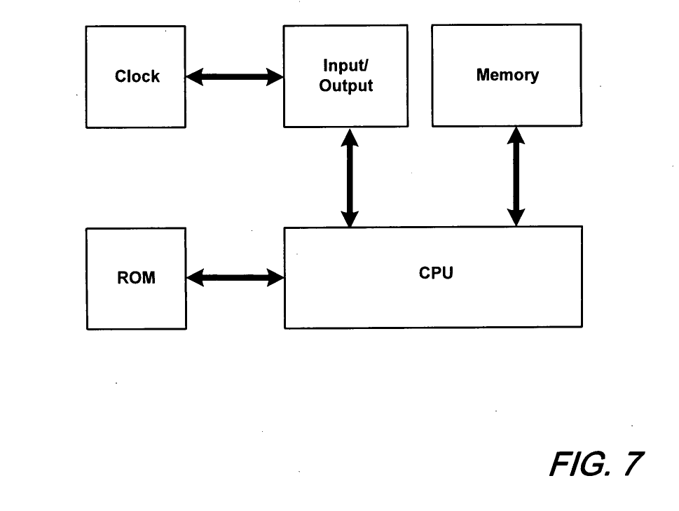

We have implemented the techniques in or SMT-based verification framework for software programs. We used yices-1.0, an SMT solver at the backend. We used as benchmarks C programs from public domain and industry, including Linux drivers, network application software, and embedded programs in portable devices. Amount the 18 benchmarks we considered, tcas is an air traffic control and avionic system with 8 assertions; ftpd is a restart module of wu-ftpd with 5 array bound violation checks; mXX examples are for a network protocol with 110 null pointer de-refrences checks; and hYY examples correspond to software for cell phone with 116 array bound violation checks. FIG. 7 shows in a schematic block diagram the components of the computer operating our computer-implemented method.

Our experiments were conducted on a workstation with 3.4 GHz, 2 GB of RAM running Linux 2.6.9-1.677. We used a time-out of 1000 s for each run. (In practice, verification engineers have to run several examples, and they typically allocate 10-20 minutes for each example.) In order to reduce overhead of running BMC multiple times for a given example, we run BMC in multiple check mode, where all properties (unresolved so far at depth k) are checked at depth k, rather than checking them in separate BMC runs.

We performed a controlled experiment with various strategies, and show the BMC comparison results in Table 1. Column 1 gives the name of the benchmark with number of properties shown in parenthesis. Columns 2-15 provide results of BMC with (+) and without (−) combinations of context-sensitive PB (PB), context-sensitive CSR(CXT), NTP checks (NTP), LFP checks (LFP), using solvers SAT or SMT Note, −CXT denotes CSR without context-sensitive analysis. To illustrate, Columns 2-3 show results for the method −PB-CXT+LFP+SAT, i.e., SAT-based BMC with LFP checks, without PB model transformation, and without CXT, where Column 2 shows number of proofs (P), witnesses found (W) and unresolved properties (P/W/?), and Column 3 shows number of BMC unrollings (D) performed with runtime (in sex) in parenthesis. As an example, for mXX1 with 22 properties, −PB−CXT+LFP+SAT times out (TO) with 0 proof and 13 witnesses at depth 115. Similar results are presented for other columns using SMT solver. For methods +PB-CXT+MFP+SMT and +PB+CXT+NTP+SMT, we also present number of NTP checks (#NTP) in Columns 12 and 15 respectively. Or methods using LFP, number of LFP checks equals D (not shown separately), as it is performed at every depth. Note, the time needed for performing PB and CXT are negligible, and so, we do not report them separately.

We use the strategy −PB−CXT+LFP+SMT as our baseline for comparison, as CFGs for the benchmarks were not reducible. Note, for some benchmarks such as teas, using methods +PB+CXT+LFP+SMT and +PB+CXT+NTP+SMT, we obtain CT=168 statically, as R(k)=0 for k>168. Thus, for these methods we skip the CT checks. Note, teas examples did not have a structured loop, but the models have unstructured loops, which were introduced during the modeling phase. In our controlled experiments, we observe that the techniques PB, CXT and NTP always help in resolving more properties, or in performing deeper and faster search, or both. In general, we see far fewer NTP checks compared to LFP checks. Overall, the strategy +PB+CXT+NTP+SMT is the clear winner.

At this point, while we have discussed and described the invention using some specific examples, those skilled in the art will recognize that our teachings are not so limited. Accordingly, the invention should be only limited by the scope of the claims attached hereto.

TABLE 1
Comparing BMC using ±PB, ±CXT, (LFP/NTP), (SMT/SAT)

| | BMC with (+)/without (−) SMT, SAT, PB: Path/Loop Balance, CXT: ConteXT- | | | | | | | |
|---|---|---|---|---|---|---|---|---|
| | sensitive LFP: Loop-Free Path Check, NTP: Non-Terminating Path Check | | | | | | | |
| | (P ≡ # Proofs, W ≡ # Witnesses, TO ≡ Time-out, D ≡ BMC Depth) | | | | | | | |
| | −PB − CXT + | | −PB − CXT + | | +PB − CXT + | | +PB + CXT + | |
| | LFP + SAT | | LFP + SMT | | LFP + SMT | | LFP + SMT | |
| Ex (#prp) | P/W/? | D (sec) | P/W/? | D (sec) | P/W/? | D (sec) | P/W/? | D (sec) |
| tcas (1) | 0/0/1 | 76 (TO) | 0/0/1 | 49 (TO) | 0/0/1 | 71 (TO) | 1/0/0 | 168 (0 s) |
| tcas0 (1) | 0/0/1 | 82 (TO) | 0/0/1 | 22 (TO) | 0/0/1 | 73 (TO) | 1/0/0 | 168 (0 s) |
| tcas1 (1) | 0/0/1 | 78 (TO) | 0/0/1 | 22 (TO) | 0/0/1 | 71 (TO) | 1/0/0 | 168 (0 s) |
| tcas2 (1) | 0/0/1 | 82 (TO) | 0/0/1 | 22 (TO) | 0/0/1 | 70 (TO) | 1/0/0 | 168 (0 s) |
| tcas3 (1) | 0/0/1 | 76 (TO) | 0/0/1 | 22 (TO) | 0/0/1 | 70 (TO) | 1/0/0 | 168 (0 s) |
| tcas4 (1) | 0/0/1 | 67 (TO) | 0/0/1 | 22 (TO) | 0/0/1 | 71 (TO) | 1/0/0 | 168 (0 s) |
| tcas5 (1) | 0/0/1 | 93 (TO) | 0/0/1 | 25 (TO) | 0/0/1 | 72 (TO) | 1/0/0 | 164 (3 s) |
| tcas6 (1) | 0/0/1 | 81 (TO) | 0/0/1 | 26 (TO) | 0/0/1 | 73 (TO) | 0/1/0 | 161 (6 s) |
| tcas7 (1) | 0/0/1 | 76 (TO) | 0/0/1 | 22 (TO) | 0/0/1 | 71 (TO) | 1/0/0 | 168 (0 s) |
| ng4 (3) | 0/2/1 | 74 (TO) | 0/2/1 | 88 (TO) | 0/2/1 | 226 (TO) | 0/2/1 | 256 (TO) |
| ok4 (2) | 0/1/1 | 67 (TO) | 0/1/1 | 94 (TO) | 0/1/1 | 233 (TO) | 0/1/1 | 257 (TO) |
| hYY1 (12) | 0/7/5 | 61 (TO) | 0/7/5 | 41 (TO) | 0/7/5 | 92 (TO) | 0/7/5 | 97 (TO) |
| hYY2 (14) | 0/10/4 | 61 (TO) | 0/9/5 | 43 (TO) | 0/8/6 | 88 (TO) | 0/8/6 | 94 (TO) |
| hYY3 (57) | 0/7/50 | 41 (TO) | 0/9/48 | 43 (TO) | 0/11/46 | 97 (TO) | 0/11/46 | 97 (TO) |
| hYY4 (33) | 0/9/24 | 53 (TO) | 0/9/24 | 45 (TO) | 0/11/22 | 79 (TO) | 0/14/19 | 97 (TO) |
| mXX1 (22) | 0/13/9 | 115 (TO) | 0/19/3 | 79 (TO) | 0/20/2 | 165 (TO) | 0/20/2 | 184 (TO) |
| mXX2 (88) | 0/46/42 | 30 (TO) | 0/41/47 | 29 (TO) | 0/55/33 | 81 (TO) | 0/56/32 | 90 (TO) |
| ftp (5) | 0/2/3 | 48 (TO) | 0/2/3 | 48 (TO) | 0/2/3 | 111 (TO) | 0/2/3 | 119 (TO) |

| | BMC with (+)/without (−) SMT, SAT, PB: Path/Loop | | | | | |
|---|---|---|---|---|---|---|
| | Balance, CXT: ConteXT-sensitive LFP: Loop-Free Path | | | | | |
| | Check, NTP: Non-Terminating Path Check (P ≡ # Proofs, | | | | | |
| | W ≡ # Witnesses, TO ≡ Time-out, D ≡ BMC Depth) | | | | | |
| | +PB − CXT + | | | +PB + CXT + | | |
| | NTP + SMT | | | NTP + SMT | | |
| Ex (#prp) | P/W/? | D (sec) | #NTP | P/W/? | D (sec) | #NTP |
| tcas (1) | 0/0/1 | 83 (TO) | 3 | 1/0/0 | 168 (0 s) | 0 |
| tcas0 (1) | 0/0/1 | 83 (TO) | 3 | 1/0/0 | 168 (0 s) | 0 |
| tcas1 (1) | 0/0/1 | 83 (TO) | 3 | 1/0/0 | 168 (0 s) | 0 |
| tcas2 (1) | 0/0/1 | 83 (TO) | 3 | 1/0/0 | 168 (0 s) | 0 |
| tcas3 (1) | 0/0/1 | 83 (TO) | 3 | 1/0/0 | 168 (0 s) | 0 |
| tcas4 (1) | 0/0/1 | 83 (TO) | 3 | 1/0/0 | 168 (0 s) | 0 |
| tcas5 (1) | 0/0/1 | 87 (TO) | 5 | 1/0/0 | 164 (3 s) | 0 |
| tcas6 (1) | 0/0/1 | 86 (TO) | 5 | 0/1/0 | 161 (6 s) | 0 |
| tcas7 (1) | 0/0/1 | 83 (TO) | 3 | 1/0/0 | 168 (0 s) | 0 |
| ng4 (3) | 1/2/0 | 430 (26 s) | 12 | 1/2/0 | 430 (26 s) | 12 |
| ok4 (2) | 1/1/0 | 331 (17 s) | 12 | 1/1/0 | 331 (17 s) | 12 |
| hYY1 (12) | 0/7/5 | 137 (TO) | 13 | 0/7/5 | 232 (TO) | 9 |
| hYY2 (14) | 0/9/5 | 146 (TO) | 14 | 0/10/4 | 195 (TO) | 8 |
| hYY3 (57) | 0/25/32 | 172 (TO) | 2 | 0/25/32 | 172 (TO) | 2 |
| hYY4 (33) | 0/15/18 | 106 (TO) | 23 | 0/21/12 | 184 (TO) | 23 |
| mXX1 (22) | 2/20/0 | 288 (132 s) | 2 | 2/20/0 | 288 (129 s) | 2 |
| mXX2 (88) | 0/56/32 | 118 (TO) | 7 | 0/56/32 | 118 (TO) | 4 |
| ftp (5) | 0/3/2 | 154 (TO) | 1 | 0/3/2 | 261 (TO) | 3 |

1. In a computer comprising a Central Processor, a Memory, and or more Input/Output devices, a bounded model checking method comprising the steps of:
loading a computer program to be checked into the memory;
generating a model of the program so loaded;
determining the longest non-terminating path in the model by
encoding the reachability of a sink control state into a SAT/SMT formula having a size linearly proportional to a sequential depth; and
outputting an indication of that longest non-terminating path via the one or more Input/Output devices.

2. A computer-implemented bounded model checking method for software comprising the steps of:
loading the software into a memory of a computer;
generating a model of the software in the memory through the effect of a processor;
determining a recurrence diameter of the model corresponding to a terminating program by encoding the reachability of a sink control stat into a SAT/SMT formula having a size proportional to a sequential depth; and
outputting an indication of that recurrence diameter.

3. In a computer comprising a Processor, Memory and Input/Output, a computer-implemented bounded model checking method for a software program comprising the steps of:
loading the program into the memory of the computer;
determining the reachability of the program through the effect of a SAT/SMT formula operating therein, wherein said SAT/SMT formula is reduced in size as a result of combining context-sensitive components with control-state reachability simplification; and
outputting the indication of that reachability.
